(19) United States
(12) Patent Application Publication
(10) Pub. No.: US 2018/0198262 A1
(43) Pub. Date: Jul. 12, 2018

(54) MULTI-PURPOSE DECORATIVE COVER FOR ELECTRICAL DISTRIBUTION SYSTEMS

(71) Applicant: James Burks, Cumming, GA (US)

(72) Inventor: James Burks, Cumming, GA (US)

(21) Appl. No.: 15/868,810

(22) Filed: Jan. 11, 2018

Related U.S. Application Data
(60) Provisional application No. 62/445,343, filed on Jan. 12, 2017.

(51) Int. Cl. H02B 1/30

(52) U.S. Cl. CPC H02B 1/30

(57) ABSTRACT

A decorative cover that is configured to be mounted to an electrical power distribution center with a substantially planar top panel; at least two substantially planar vertical side wall panels, each connected to an edge of the top panel such that each wall is perpendicularly disposed to the top panel and the vertical side walls together define a cavity; and at least one decorative panel member with a means to attach the panel member to at least one side wall panel or top panel.

### RELATED APPLICATIONS

This application claims priority to U.S. Provisional Application No. 62/445,343 filed Jan. 12, 2017. The entire contents of the above application are hereby incorporated by reference as though fully set forth herein.

### BACKGROUND

The present invention relates to electrical power distribution service panels; and more particularly, to coverings for electrical power distribution systems with or without service columns.

Electrical panels installed at outdoor electrical power distribution systems include housings for housing various components used for switching, metering, bus bar circuit interconnections, breaker panels and overload electrical protection as well as columns staking the system into the ground. Typically, in real life situations, architects and engineers place the power distribution systems in highly visible outdoor locations. While the placement meets minimum safety requirement regulations, the electrical power distribution systems and their related service columns are unattractive and not compatible or complimentary with the decorative style of the surrounding buildings. As a result, often the owners of the property use expensive landscaping to improve the aesthetic appeal of the area. As such, it would be useful to provide a covering for an electrical power distribution system, with or without a service column, that has a decorative front cover that conceals outdoor electrical power distribution panels and columns yet still allows access to circuit breakers, fuses or meters within the panel board housing. By having the ability to add artistic architectural features to the covering, the need for expensive landscaping would be eliminated.

### BRIEF SUMMARY OF THE INVENTION

It is an object of the present invention to provide a decorative device for camouflaging the unattractive aspects of conventional electrical power distribution systems and their associated service columns and bringing about aesthetically pleasant housings which harmonize with the decorative style of the surrounding buildings or landscape where the electrical power distribution system is installed.

It is a further object of the present invention to provide a retrofitting kit for a cover that is easily installable over the electrical distribution system and its associated electrical column. The retrofitting kit includes hardware for installation of the cover over the electrical distribution system and the electrical column.

It is a further object of the present invention to provide a retrofitting kit including a plurality of distinct decorative covers which are easily installable to the electrical distribution system cover and replaceable in an interchangeable manner. The retrofitting kit includes hardware for installation of each decorative cover to the electrical panel board.

It is another object of the present invention to provide a method of camouflaging a conventional electrical distribution system and its associated electrical service columns in outdoor areas with attractive and aesthetically pleasant decorative covers.

### BRIEF DESCRIPTION OF THE DRAWINGS

FIG. 1 is an exemplary electrical distribution system on a service column that is housed within the housing of the present invention.

FIG. 2 is a front view of the fully assembled electrical distribution system on a service column housing of the present invention.

FIG. 3 is a back view of one embodiment of the electrical distribution system on a service column housing of the present invention.

FIG. 4 is a top view of one embodiment of the electrical distribution system on a service column housing of the present invention.

FIG. 5 is a side view of one embodiment of the electrical distribution system on a service column housing of the present invention.

FIG. 6 is a back view of one embodiment of the electrical distribution system on a service column housing of the present invention.

FIG. 7 is a back view of one embodiment of the electrical distribution system on a service column housing of the present invention.

FIG. 8 is a back view of one embodiment of the electrical distribution system on a service column housing of the present invention.

FIG. 9 is a top view of one embodiment of the electrical distribution system on a service column housing of the present invention.

FIG. 10 is a front view of one embodiment of the electrical distribution system on a service column housing of the present invention.

FIG. 11 is a view of the various components of one embodiment of the electrical distribution system on a service column housing of the present invention.

### DETAILED DESCRIPTION

The present invention is a device and method for providing an aesthetically attractive look to electrical distribution systems and their associated service columns in accordance with the taste and preference and decorative style of the surrounding buildings and/or landscape.

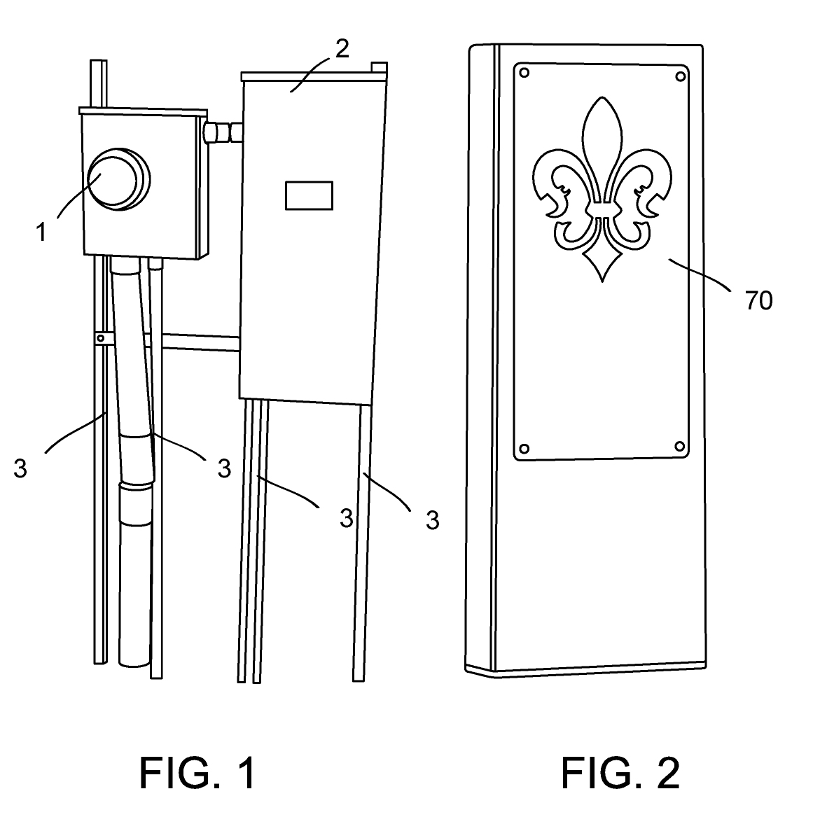

Turning the FIG. 1, an exemplarily electrical distribution center on a service column is shown with a metering device 1 staked into the ground on the left and a panel breaker box 2 staked into the ground on the right. The configuration has haphazard and unattractive components supporting the columns 3 in the ground.

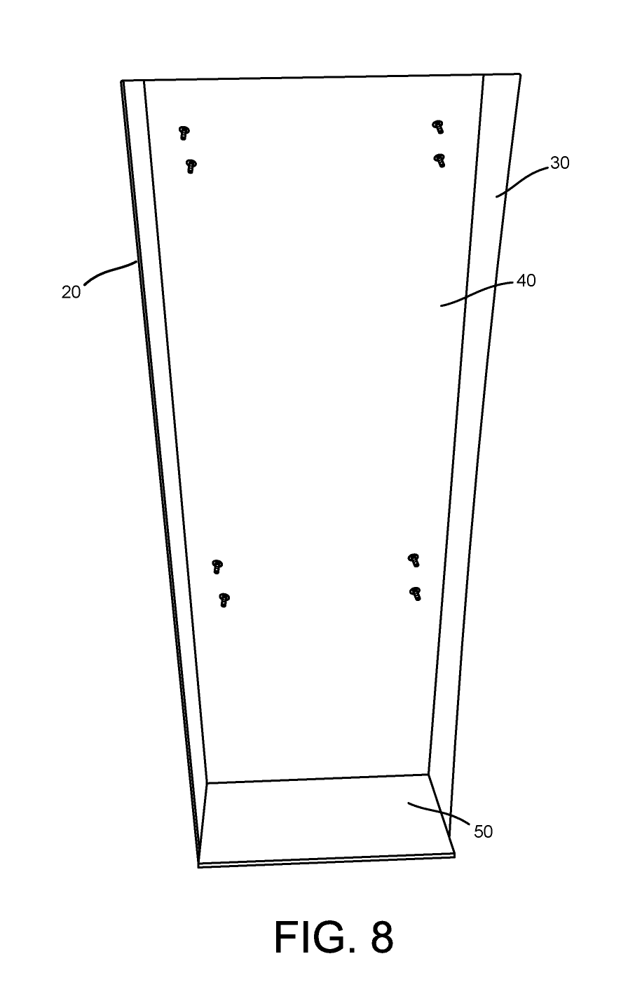

Turning to FIGS. 2, 3 and 8, the electrical distribution system on a service column housing has a substantially planar top panel 10 and three substantially planar vertical side wall panels 20, 30 and 40. Each vertical wall panel is connected to an edge of the top panel 10 such that each wall is perpendicularly disposed to the top panel and the three vertical side walls together define a cavity. In the preferred embodiment, the vertical side walls are substantially rectangular and the cavity formed has a rectangular cross-section. The housing has at least one decorative front member 70 with a means to affix the front member to at least one side wall panel or top panel. The decorative front member 70 may be permanently or removably affixed on any of the side walls or top panel. The means for attachment include, but are not limited to, welding, bolting, screwing, using magnetic devices and combinations thereof.

In the preferred embodiment, the housing is constructed from metal, composite material, plastics, polymers or combinations thereof. The width dimension of the housing is generally slightly larger than the width dimension of the electrical distribution system to be located within the housing. The height dimension of the housing is determined based on electrical code requirements in each county as well as according to user preference.

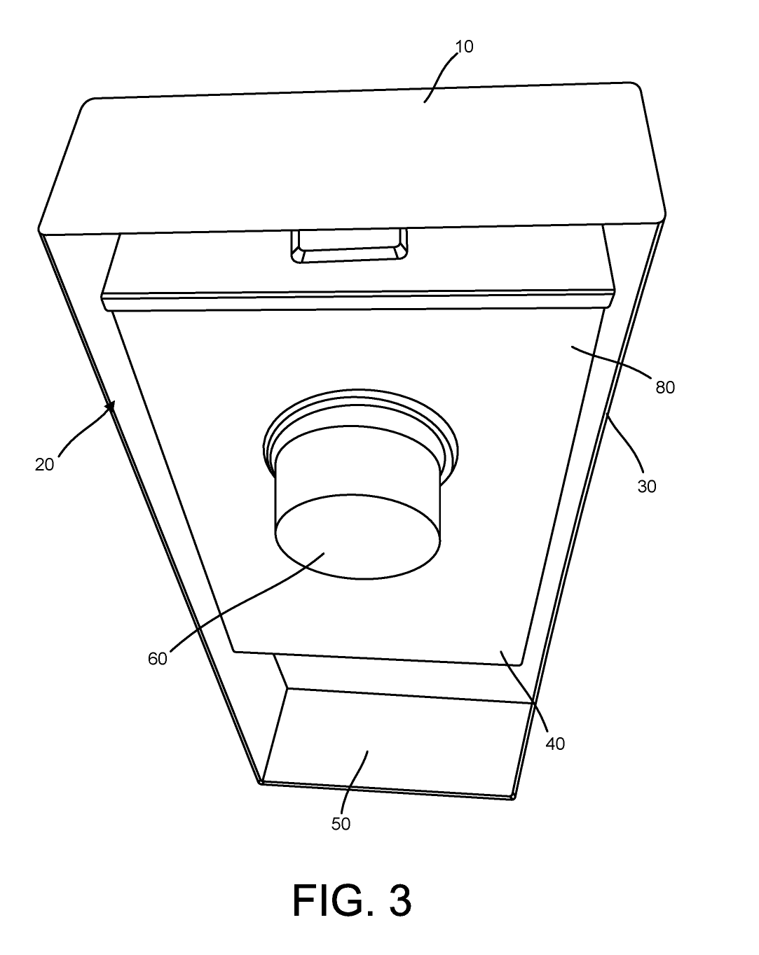

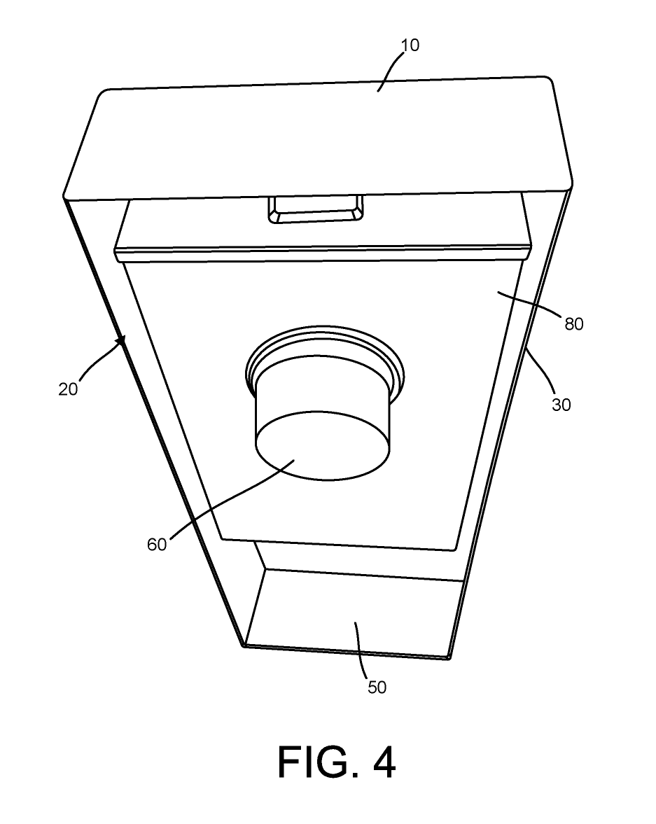

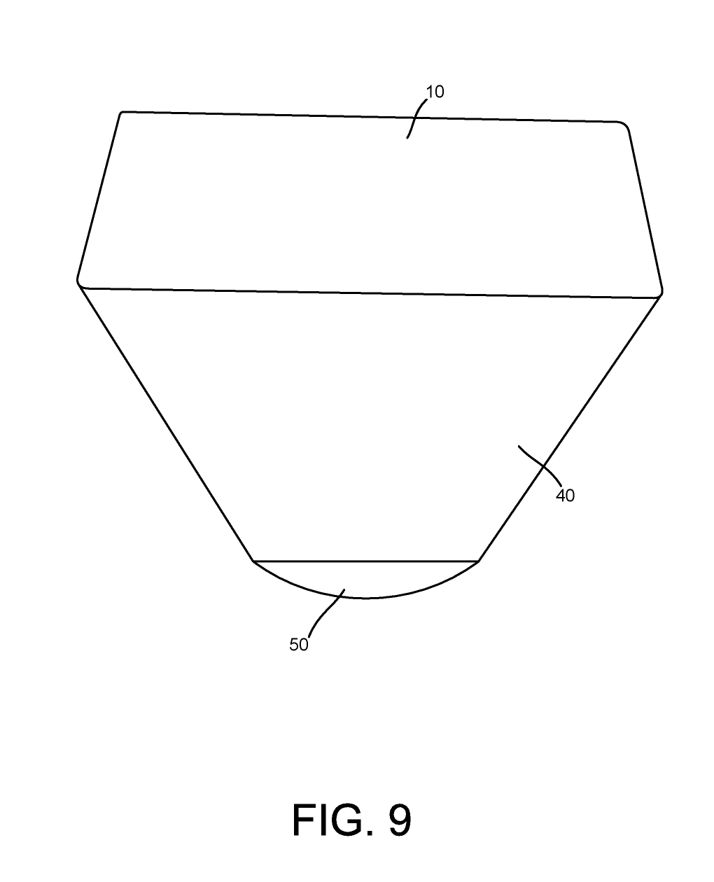

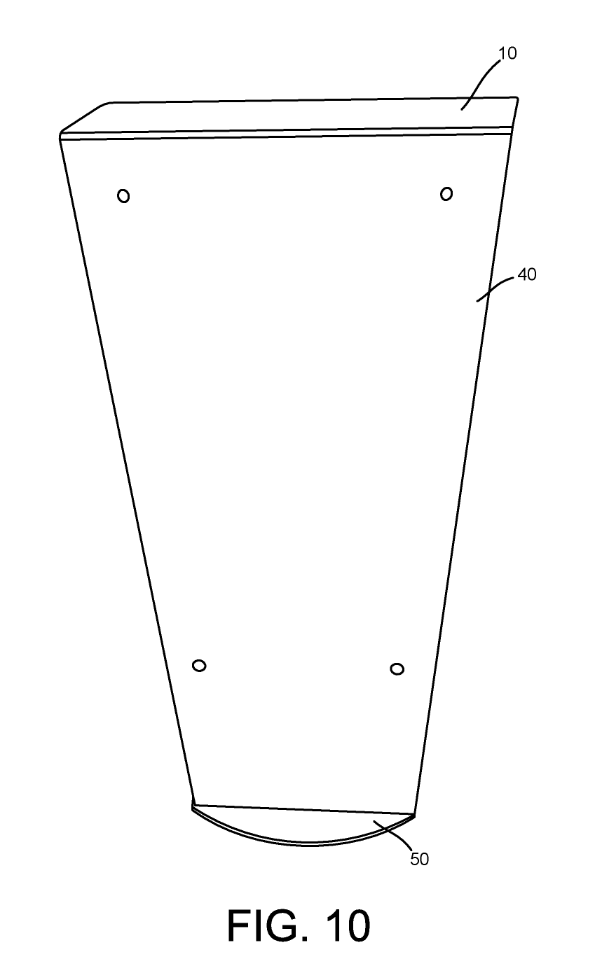

Turning to FIGS. 3-4 and 9-10, various views of the housing show the substantially planar top panel 10 and three vertical side wall panels 20, 30 and 40. In the preferred embodiment, the bottom end is open so that the service column can be staked into the ground. However, for display purposes, the bottom end may be a substantially planar bottom panel 50. Inside the housing is an electrical meter 60.

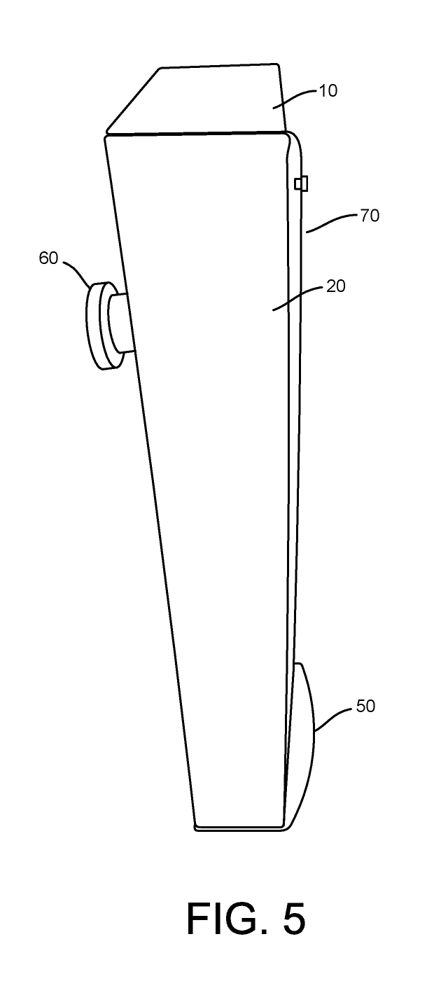

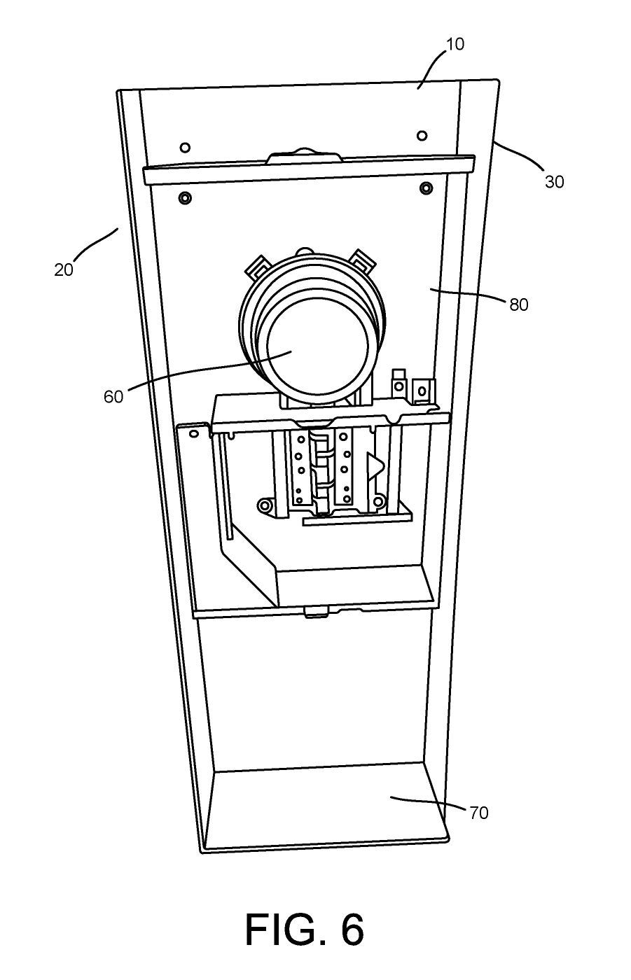

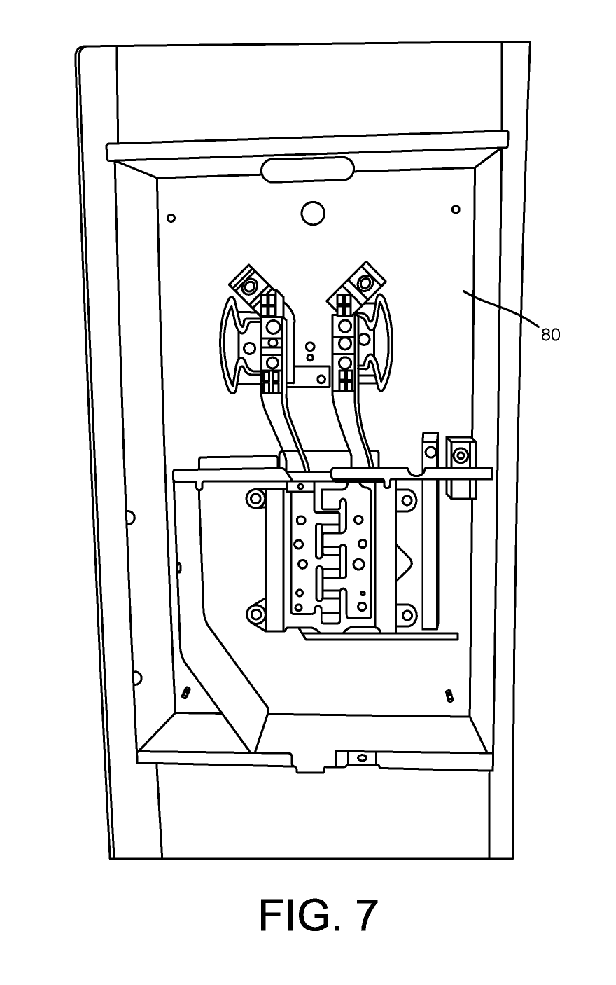

Turning to FIG. 5, in the preferred embodiment, the electrical meter 60 faces opposite the decorative panel member 70. Turning to FIGS. 6-8, since the cavity created by the three vertical side walls and planar top panel is open at the meter side, the meter can be easily opened and even removed without having to move the housing, thereby preserving the aesthetic appeal. In the preferred embodiment, the shell 80 of the meter or other electrical components of an electrical distribution center is secured inside the cavity by attaching directly to at least of the vertical side walls.

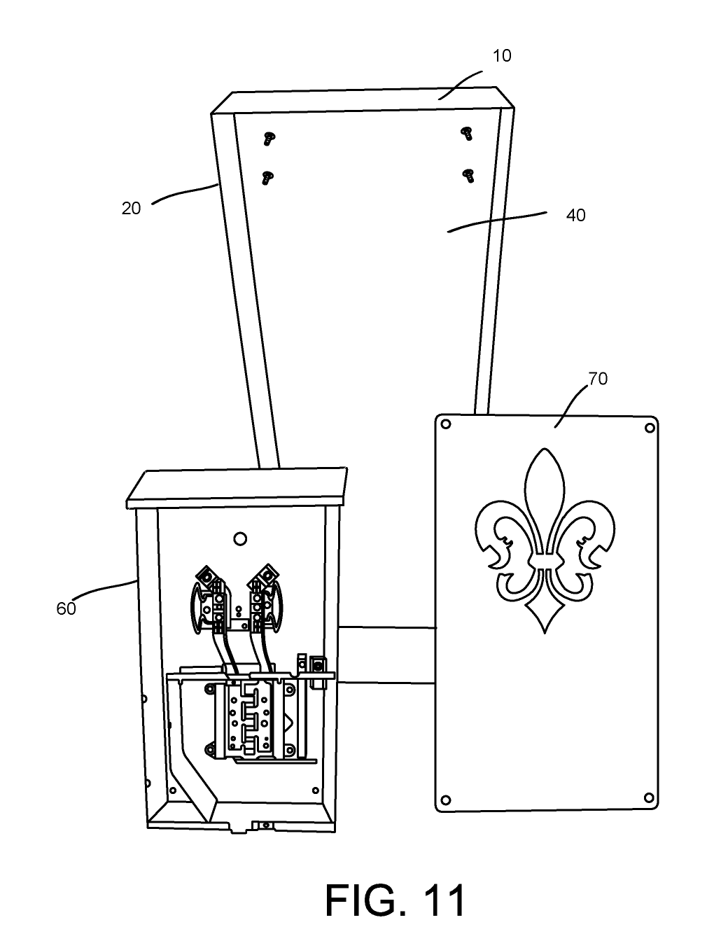

Turning to FIG. 11, the decorative panel member 70 can be detached from the vertical side wall and replaced with decorative panel members of various styles and designs as needed. It is contemplated that the decorative panel member may also be attached to any of the other vertical side walls 20, 30 or 40 or even the top panel 10.

In some embodiments, the housing is directly buried into the ground at the open bottom end at about 2-3 feet in depth and concrete may further secure the housing in the ground, with the remaining housing extending upward from the ground.

While it is preferred that the electrical distribution system and it associated service column is initially installed with the housing, many electrical distribution systems are already installed and are not aesthetically pleasing. As such, the present invention can be manufactured as a retrofitting kit that can be installed to cover existing electrical distribution systems, with or without service columns, and may be manufactured in a variety of shapes and sizes as is necessary to cover a distinct design of an electrical distribution system.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A decorative cover that is configured to be mounted to an electrical power distribution center comprising:
a. a substantially planar top panel;
b. at least two substantially planar vertical side wall panels, each connected to an edge of the top panel such that each wall is perpendicularly disposed to the top panel and the vertical side walls together define a cavity; and
c. at least one decorative panel member with a means to attach the panel member to at least one side wall panel or top panel.

2. The device of claim 1 wherein the vertical side walls are rectangular and the cavity formed has a rectangular cross-section.

3. The device of claim 1 wherein the decorative panel member is permanently attached on any of the side walls or top panel.

4. The device of claim 1 wherein the decorative panel member is removably attached on any of the side walls or top panel.

5. The device of claim 1 wherein the top panel and side panels materials are selected from the group comprising metal, composite, plastics, polymers or combinations thereof.

6. The device of claim 1 wherein the decorative panel material is selected from the group comprising metal, composite, plastics, polymers or combinations thereof.

7. A kit for installing a decorative cover configured to be mounted to an electrical power distribution system comprising:
a. a housing comprising
i. a substantially planar top panel;
ii. substantially planar vertical side wall panels, each connected to an edge of the top panel such that each wall is perpendicularly disposed to the top panel and the vertical side walls together define a cavity;
b. a decorative panel member; and
c. at least one securing device to secure at least one decorative member to at least one of the top or side wall panels.

8. The kit of claim 7 wherein the securing devices are selected from the group comprising bolts, screws, magnets, clips or combinations thereof.

9. The kit of claim 7 further comprising at least one additional decorative panel member.

10. The kit of claim 9 wherein the decorative panel member is removably attached and replaced with the additional decorative panel member.

11. The kit of claim 7 wherein the top panel and side panels materials of the housing are selected from the group comprising metal, composite, plastics, polymers or combinations thereof.

12. The kit of claim 7 wherein the decorative panel material is selected from the group comprising metal, composite, plastics, polymers or combinations thereof.

13. A method of installing a decorative cover onto an electrical power distribution system, comprising the steps of:
a. covering the electrical power distribution with a housing comprising
i. a substantially planar top panel; and
ii. substantially planar vertical side wall panels, each connected to an edge of the top panel such that each wall is perpendicularly disposed to the top panel and the vertical side walls together define a cavity; and
b. attaching a decorative panel member using at least one securing device to at least one of the top panel or side walls.

14. The method of claim 13 further comprising burying a portion of the side wall panels into a portion of the ground surrounding the electrical distribution system.

15. The method of claim 14 further comprising pouring concrete around the side wall panels buried into the ground.
